(19) United States
(12) Patent Application Publication
(10) Pub. No.: US 2023/0356179 A1
(43) Pub. Date: Nov. 9, 2023

(54) COMBINED ADSORPTION AND CATALYSIS FOR CABIN AIR POLLUTION CONTROL

(71) Applicant: BASF CORPORATION, Florham Park, NJ (US)

(72) Inventors: Mark Thomas BUELOW, Iselin, NJ (US); Wolfgang RUETTINGER, Iselin, NJ (US); Laif R. ALDEN, Iselin, NJ (US); Gerard Diomede LAPADULA, Iselin, NJ (US)

(21) Appl. No.: 18/014,602

(22) PCT Filed: Jul. 9, 2021
(86) PCT No.: PCT/US2021/041022

§ 371 Date: Jan. 5, 2023

Related U.S. Application Data
(60) Provisional application No. 63/049,937, filed on Jul. 9, 2020.

(51) Int. Cl. B01J 20/04; B01J 20/16; B01J 21/04; B01J 23/63; B01J 20/02; B01D 53/86

(52) U.S. Cl. CPC B01J 20/041; B01J 20/165; B01J 21/04; B01J 23/63; B01J 20/0222; B01D 53/8637; B01D 2255/1021; B01D 2255/2092; B01D 2253/1124; B01D 2253/108; B01D 2257/402; B01D 2257/404; B01D 2257/406; B01D 2257/302; B01D 2258/06

(57) ABSTRACT

Disclosed in certain embodiments are systems for removing pollutants from an air flow, which may include a substrate and a catalyst-adsorbent material disposed on the substrate.

### CROSS-REFERENCE TO RELATED APPLICATION(S)

This application claims the benefit of priority of U.S. Provisional Patent Application No. 63/049,937, filed on Jul. 9, 2020, the disclosure of which is hereby incorporated by reference herein in its entirety.

### TECHNICAL FIELD

The present disclosure relates to compositions, devices, and methods for air purification. More particularly, the disclosure relates to catalyst-adsorbent materials, devices, and systems, methods of their preparation, and methods of their use for removal of gaseous pollutants from air.

### BACKGROUND

Traditional pollutant treatment systems and sorbent materials face many challenges, including improving long term performance, increasing the efficiency of manufacturing operations, and reducing production costs. Many sorbent materials are generally adapted for one type of adsorption application, while being unable to remove other types of pollutants.

Cabin air purification in aircraft is one example where removal of multiple types of pollutants, such as volatile organic compound (VOCs), is critical. The air supplied to the cabin air of aircraft is in part derived from ambient air compressed by the aircraft engine or an auxiliary power unit. This air can contain various VOCs present in the atmosphere or resulting from leaks in the aircraft equipment. Traditional catalysts require higher temperature than is often available during times when concentrations of these VOCs are significant, such as during a fume event.

Thus, there continues to be a need for devices, methods, and compositions that can effectively remove multiple pollutants simultaneously.

### SUMMARY OF THE DISCLOSURE

The following presents a simplified summary of various aspects of the present disclosure in order to provide a basic understanding of such aspects. This summary is not an extensive overview of the disclosure. It is intended to neither identify key or critical elements of the disclosure, nor delineate any scope of the particular embodiments of the disclosure or any scope of the claims. Its sole purpose is to present some concepts of the disclosure in a simplified form as a prelude to the more detailed description that is presented later.

In one aspect of the present disclosure, a system for removing pollutants from an air flow comprises: a substrate; a catalyst-adsorbent material disposed on the substrate, the catalyst-adsorbent material comprising an adsorbent material and a catalyst material. In at least one embodiment, the catalyst-adsorbent material is adapted to adsorb pollutants at a first temperature of 20-150° C. and catalyze adsorbed pollutants at a second temperature of 120-300° C.

In at least one embodiment, the adsorbent material comprises one or more of silica gel, alumina, activated carbon, faujasite, chabazite, clinoptilolite, mordenite, silicalite, zeolite X, zeolite Y, ultrastable zeolite Y, ZSM zeolite, offretite, beta zeolite, metal organic frameworks, metal oxide, polymers, or resins.

In at least one embodiment, the adsorbent material comprises one or more of a basic metal oxide or an alkali-modified or alkaline earth-modified metal oxide.

In at least one embodiment, the adsorbent material comprises one or more of a potassium-modified manganese oxide or a sodium-exchanged zeolite.

In at least one embodiment, the catalyst material comprises one or more of manganese, platinum, palladium, or cerium.

In at least one embodiment, the catalyst-adsorbent material comprises platinum particles having a diameter of 2 nanometers to 5 nanometers and manganese oxide.

In at least one embodiment, the catalyst-adsorbent material comprises platinum particles having a diameter of 2 nanometers to 5 nanometers, manganese, and cerium.

In at least one embodiment, the catalyst-adsorbent material comprises platinum-modified alumina and potassium-modified manganese oxide.

In at least one embodiment, the catalyst-adsorbent material comprises platinum-modified alumina, potassium-modified manganese oxide, and zeolite.

In at least one embodiment, the pollutants comprise one or more volatile organic compounds.

In at least one embodiment, the one or more volatile organic compounds comprise one or more of pentanoic acid, acetaldehyde, toluene, turbine oil compounds, polyol esters, tri-cresyl phosphate, phosphate esters, hydraulic fluid compounds, jet fuel compounds, dodecane, propionic acid, or carboxylic acids.

In at least one embodiment, the pollutants comprise one or more of SO₂, NH₃, NO₂, NO, or formaldehyde.

In at least one embodiment, the catalyst-adsorbent material comprises a washcoat formed on the substrate, the washcoat comprising a physical mixture of the adsorbent material and the catalyst material.

In at least one embodiment, the washcoat comprises a polymeric binder. In at least one embodiment, the polymeric binder is selected from a group consisting of: polyethylene, polypropylene, polyolefin copolymer, polyisoprene, polybutadiene, polybutadiene copolymer, chlorinated rubber, nitrile rubber, polychloroprene, ethylene-propylene-diene elastomer, polystyrene, polyacrylate, polymethacrylate, polyacrylonitrile, poly(vinyl ester), poly(vinyl halide), polyamide, cellulosic polymer, polyimide, acrylic polymer, vinyl acrylic polymer, styrene acrylic polymer, polyvinyl alcohol, thermoplastic polyester, thermosetting polyester, poly(phenylene oxide), poly(phenylene sulfide), fluorinated polymer, poly(tetrafluoroethylene) polyvinylidene fluoride, poly(vinylfluoride) chloro/fluoro copolymer, ethylene chlorotrifluoroethylene copolymer, polyamide, phenolic resin, epoxy resin, polyurethane, acrylic/styrene acrylic copolymer, latex, silicone polymer, and combinations thereof.

In at least one embodiment, the washcoat comprises an inorganic binder. In at least one embodiment, the inorganic binder comprises one or more of a silica sol or an alumina sol.

In another aspect of the present disclosure, a system for removing pollutants from an air flow comprises: a first catalyst-adsorbent material layer on a first substrate; and a second catalyst-adsorbent material layer on a second substrate downstream from the first substrate. In at least one embodiment, one or more of the first catalyst-adsorbent material layer or the second catalyst-adsorbent material layer is adapted to adsorb pollutants at a first temperature of 20-150° C. and catalyze adsorbed pollutants at a second temperature of 120-300° C.

In another aspect of the present disclosure, a system for removing pollutants from an air flow comprises: a first catalyst-adsorbent material layer to adsorb a pollutant and/or generate an intermediate compound from the pollutant; and a second catalyst-adsorbent material layer downstream from the first catalyst-adsorbent material layer. In at least one embodiment, the second catalyst-adsorbent material layer is adapted to convert the pollutant after desorption from the first catalyst-adsorbent material layer and/or the intermediate compound

In another aspect of the present disclosure, a system for removing pollutants from an air flow comprises: a substrate; and a catalyst-adsorbent material disposed on the substrate. In at least one embodiment, the catalyst-adsorbent material comprises: a first layer comprising an adsorbent material; and a second layer comprising a catalyst material. In at least one embodiment, the first layer is disposed above the substrate, and the second layer is disposed above the first layer.

In another aspect of the present disclosure, an aircraft environmental control system for removing pollutants from aircraft cabin air comprises any of the systems described herein.

In another aspect of the present disclosure, an aircraft environmental control system comprises a catalytic convertor for removing pollutants from aircraft cabin air, the catalytic convertor comprising the system of any of the systems described herein.

In another aspect of the present disclosure, a method of removing pollutants from an air flow comprises: contacting the air flow with a catalyst-adsorbent comprising at least one adsorbent material and at least one catalyst material; and heating the catalyst-adsorbent to a temperature above 150° C. to promote catalytic conversion of at least a portion of the adsorbed pollutants. In at least one embodiment, the catalyst-adsorbent is maintained at a first temperature below 200° C. during the contacting to adsorb the pollutants.

As used herein, the terms “adsorbent” or “adsorbent material” refer to a material that can adhere gas molecules, ions, or other species within its structure (e.g., removal of CO2 from air). Specific materials include but are not limited to clays, metal organic framework, activated alumina, silica gel, activated carbon, molecular sieve carbon, zeolites (e.g., molecular sieve zeolites), polymers, resins, and any of these components or others having a gas-adsorbing material supported thereon (e.g., such as the various embodiments of sorbents described herein). Certain adsorbent materials may preferentially or selectively adhere particular species.

Also as used herein, the term “catalyst-adsorbent” refers to a material that has dual catalytic and adsorptive properties. For example, a catalyst-adsorbent layer, upon contact with a molecular species, may catalyze the conversion of the molecular species into one or more byproducts, and may also be capable of adsorbing the molecular species and/or the one or more byproducts. The catalyst-adsorbent layer may also be capable of adsorbing other molecular species that cannot be reacted catalytically by the catalyst-adsorbent layer.

As used herein, the term “adsorption capacity” refers to a working capacity for an amount of a chemical species that an adsorbent material can adsorb under specific operating conditions (e.g., temperature and pressure). The units of adsorption capacity, when given in units of mg/g, correspond to milligrams of adsorbed gas per gram of sorbent.

Also as used herein, the term “particles” refers to a collection of discrete portions of a material each having a largest dimension ranging from 0.1 μm to 50 mm. The morphology of particles may be crystalline, semi-crystalline, or amorphous. The size ranges disclosed herein can be mean/average or median size, unless otherwise stated. It is noted also that particles need not be spherical, but may be in a form of cubes, cylinders, discs, or any other suitable shape as would be appreciated by one of ordinary skill in the art. “Powders” and “granules” may be types of particles.

Also as used herein, the term “monolith” refers to a single unitary block of a particular material. The single unitary block can be in the form of, e.g., a brick, a disk, or a rod and can contain channels for increased gas flow/distribution. In certain embodiments, multiple monoliths can be arranged together to form a desired shape. In certain embodiments, a monolith may have a honeycomb shape with multiple parallel channels each having a square shape, a hexagonal shape, or another other shape.

Also as used herein, the term “dispersant” refers to a compound that helps to maintain solid particles in a state of suspension in a fluid medium, and inhibits or reduces agglomeration or settling of the particles in the fluid medium.

Also as used herein, the term “binder” refers to a material that, when included in a coating, layer, or film (e.g., a washcoated coating, layer, or film on a substrate), promotes the formation of a continuous or substantially continuous structure from one outer surface of the coating, layer, or film through to the opposite outer surface, is homogeneously or semi-homogeneously distributed in the coating, layer, or film, and promotes adhesion to a surface on which the coating, layer, or film is formed and cohesion between the surface and the coating, layer, or film.

Also as used herein, the terms “stream” or “flow” broadly refer to any flowing gas that may contain solids (e.g., particulates), liquids (e.g., vapor), and/or gaseous mixtures.

Also as used herein, the terms “volatile organic compounds” or “VOCs” refer to organic chemical molecules having an elevated vapor pressure at room temperature. Such chemical molecules have a low boiling point and a large number of the molecules evaporate and/or sublime at room temperature, thereby transitioning from a liquid or solid phase to a gas phase. Common VOCs include, but are not limited to, formaldehyde, benzene, toluene, xylene, ethylbenzene, styrene, propane, hexane, cyclohexane, limonene, pinene, acetaldehyde, hexaldehyde, ethyl acetate, butanol, and the like.

Also as used herein, the terms “unpurified air” or “unpurified air stream” refer to any stream that contains one or more pollutants at a concentration or content at or above a level that is perceived as nuisance, is considered to have adverse effects on human health (including short term and/or long term effects), and/or causes adverse effects in the operation of equipment. For example, in certain embodiments, a stream that contains formaldehyde at a concentration greater than 0.5 part formaldehyde per million parts of air stream calculated as an eight hour time weighted average concentration pursuant to “action level” standards set forth by the Occupational Safety & Health Administration is an unpurified air stream. In certain embodiments, a stream that contains formaldehyde at a concentration greater than 0.08 part formaldehyde per million parts of air stream calculated as an eight hour time weighted average concentration pursuant to national standards in China is an unpurified air stream. Unpurified air may include, but is not limited to, formaldehyde, ozone, carbon monoxide (CO), VOCs, methyl bromide, water, amine-containing compounds (e.g., ammonia), sulfur oxides, hydrogen sulfide, and nitrogen oxides.

Also as used herein, the terms “purified air” or “purified air stream” refer to any stream that contains one or more pollutants at a concentration or content that is lower than the concentration or content of the one or more pollutants in what would be considered an unpurified air stream.

Also as used herein, the term “substrate” refers to a material (e.g., a metal, semi-metal, semi-metal oxide, metal oxide, polymeric, ceramic, paper, pulp/semi-pulp products, etc.) onto or into which the catalyst is placed. In certain embodiments, the substrate may be in the form of a solid surface having a washcoat containing a plurality of catalytic particles and/or adsorbent particles. A washcoat may be formed by preparing a slurry containing a specified solids content (e.g., 30-50% by weight) of catalytic particles and/or adsorbent particles, which is then coated onto a substrate and dried to provide a washcoat layer. In certain embodiments, the substrate may be porous and the washcoat may be deposited outside and/or inside the pores.

Also as used herein, the term “nitrogen oxide” refers to compounds containing nitrogen and oxygen including but not limited to, nitric oxide, nitrogen dioxide, nitrous oxide, nitrosylazide, ozatetrazole, dinitrogen trioxide, dinitrogen tetroxide, dinitrogen pentoxide, trinitramide, nitrite, nitrate, nitronium, nitrosonium, peroxonitrite, or combinations thereof.

Also as used herein, the term “sulfur compounds” refers to compounds containing sulfur including but not limited to sulfur oxides (sulfur monoxide, sulfur dioxide, sulfur trioxide, disulfur monoxide, disulfur dioxide), hydrogen sulfide, or combinations thereof.

Also as used herein, the term “about,” as used in connection with a measured quantity, refers to the normal variations in that measured quantity, as expected by the skilled artisan making the measurement and exercising a level of care commensurate with the objective of measurement and the precision of the measuring equipment. For example, when “about” modifies a value, it may be interpreted to mean that the value can vary by ±1%.

Surface area, as discussed herein, is determined by the Brunauer-Emmett-Teller (BET) method according to DIN ISO 9277:2003-05 (which is a revised version of DIN 66131), which is referred to as “BET surface area.” The specific surface area is determined by a multipoint BET measurement in the relative pressure range from 0.05-0.3 p/p₀.

### BRIEF DESCRIPTION OF THE DRAWINGS

The present disclosure is illustrated by way of example, and not by way of limitation, in the figures of the accompanying drawings, in which:

FIG. 1 depicts an illustrative air-flow system in accordance with an embodiment of the disclosure;

FIG. 2A depicts a cross-section of an exemplary substrate having a catalyst-adsorbent material coating formed thereon in accordance with an embodiment of the disclosure;

FIG. 2B depicts a cross-section of a catalyst-adsorbent material coating formed on a surface substrate in accordance with an embodiment of the disclosure;

FIG. 3 shows an x-ray diffraction spectrum for manganese oxide polymorph I in accordance with an embodiment of the disclosure; and

FIG. 4 is a flow diagram illustrating a method of forming a catalyst-adsorbent material on a substrate in accordance with an embodiment of the disclosure.

### DETAILED DESCRIPTION

The embodiments described herein relate to catalyst-adsorbent materials and systems for removing pollutants from air. More specifically, the catalyst-adsorbent materials may be incorporated into indoor air, cabin air (e.g., aircraft cabin air), and cathode air purification systems, which may be designed to remove toxic chemical pollutants such as formaldehyde, pentanoic acid, acetaldehyde, toluene, ozone, carbon monoxide, nitrogen oxides, sulfur dioxide, amines (including ammonia), sulfur compounds (including thiols), chlorinated hydrocarbons, and other alkali or acidic chemicals. The catalyst-adsorbent material may comprise adsorbents that are, for example, physically blended with catalysts in one or more layers of a washcoat, or present in specific layers of a washcoat. In some embodiments, the adsorbent material may be implemented as zones such as on catalyst segments at the leading face such that, when VOCs are desorbed, they pass through downstream VOC oxidation catalysts for removal from the air stream. In some embodiments, pollutants are adsorbed at temperatures from 20-150° C. (e.g., 20-40° C., 40-60° C., 60-80° C., 80-100° C., 100-120° C., or 120-150° C.) and desorbed/catalyzed at temperatures from 120-300° C. (e.g., 120-150° C., 150-200° C., 200-250° C., or 250-300° C.). In some embodiments, the temperature of adsorption is lower than the temperature of desorption/catalysis.

Certain embodiments described herein are contemplated for use in aircraft cabin air treatment. Aircraft typically fly at higher altitudes for more fuel-efficient operation. At higher altitudes, the atmosphere contains a high level of ozone, and ozone plumes encountered at some altitudes have even higher ozone concentrations. The presence of ozone in the atmosphere can provide protection from ultra-violet rays but can also be harmful when inhaled. This air and the air existing within aircraft cabins contain many other components in addition to ozone including NOx, volatile organic compounds (“VOCs”) and other undesired compounds and particulate matter. Air from the atmosphere is typically supplied to the cabin through the engine of the aircraft. As outside air enters the compressor of the engine, it is compressed and heated to a higher pressure and temperature. The heated and pressurized air from the engine, commonly referred to as “bleed air,” is extracted from the compressor by bleed air ports which control the amount of air extracted. The bleed air is fed to an environmental control system (“ECS”). After the bleed air passes through the catalyst and ECS, during which ozone and other pollutants may be removed and the temperature and pressure adjusted, the bleed air is sometimes circulated to the air-conditioning packs where it is further cooled to a set temperature for introduction to the cabin.

Embodiments of the present disclosure can be used to reduce the VOC content of the air supplied to the cabin air of aircraft to improve the comfort or health of the passengers and crew. By blending adsorbent such as zeolites (e.g. dealuminated Y, high silica-to-alumina ratio (SAR) beta, ZSMs, etc.) or potassium-promoted manganese oxide with highly active VOC oxidation catalysts (e.g. platinum- and/or manganese-based, etc.), it is possible to capture compounds such as pentanoic acid when the catalyst-adsorbent material is at, for example, about 120° C. (e.g., during fume events) and oxidize those VOCs when the catalyst-adsorbent is subsequently heated to, for example, 200° C. in operation. This higher temperature oxidation of VOCs will also enhance the life of the converter and regenerate the adsorbent for later cycles of low temperature VOC exposure, thus providing a robust catalyst-adsorbent system that can function over the broad range of temperatures available on aircraft.

Moreover, the embodiments advantageously allow for high adsorption capacity of typical VOCs such as pentanoic acid, acetaldehyde, or toluene so that these compounds can be reduced at low temperature, and also high catalytic activity to convert either the pre-adsorbed VOCs or direct conversion of air contaminants at times when the air stream is at normal operating temperatures. These embodiments further allow for effective catalysis without the use of ultra-violet (UV) radiation or electricity, and are free of photo-catalytic chemistry.

The embodiments of the present disclosure further allow for the formation of catalyst-adsorbent filters that are free of detectable odors even after long term operation.

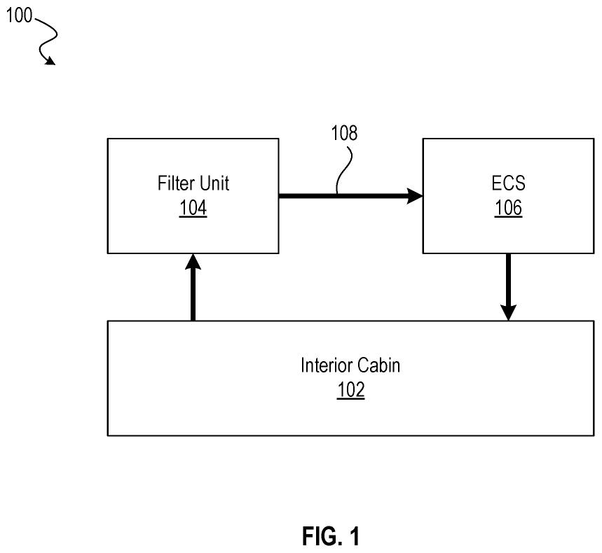

FIG. 1 depicts an illustrative air-flow system 100 in accordance with an embodiment of the disclosure. The system 100 includes a filter unit 104, an environmental control system (ECS), such as an aircraft ECS, and an interior cabin 102, such as an aircraft cabin. As shown in FIG. 1, the filter unit 104 and the ECS 106 are fluidly coupled to each other and to the interior cabin 102 such that a recirculation air flow path 108 is established. As various pollutants, such as VOCs, and odors accumulate within the cabin 102, interior air is recirculated through the filter unit 104 to catalyze and/or adsorb the pollutants using a catalyst-adsorbent filter, as described herein. Purified air then passes through the ECS 106, which may be further filtered (e.g., to remove dust and other particulates) and may be heated or cooled before being recirculated back into the interior cabin 102. Filtered interior cabin air may be recirculated to the ECS 106 and mixed with bleed air (e.g., after passing through the filter unit 104). The mixture of recirculated cabin air and treated bleed air is then supplied to the interior cabin 102.

The embodiment of the air-flow system 100 is merely illustrative, and it is to be understood that the embodiments of catalyst-adsorbent filters described herein may be incorporated into other systems for treating air, such as an automobile ventilation system, an air control system for treating atmospheric air, humidifying/dehumidifying systems, odor removal systems, VOC scrubbing systems, treatment systems for cathode air in fuel cell systems for cars, homes, or industrial use, and other systems.

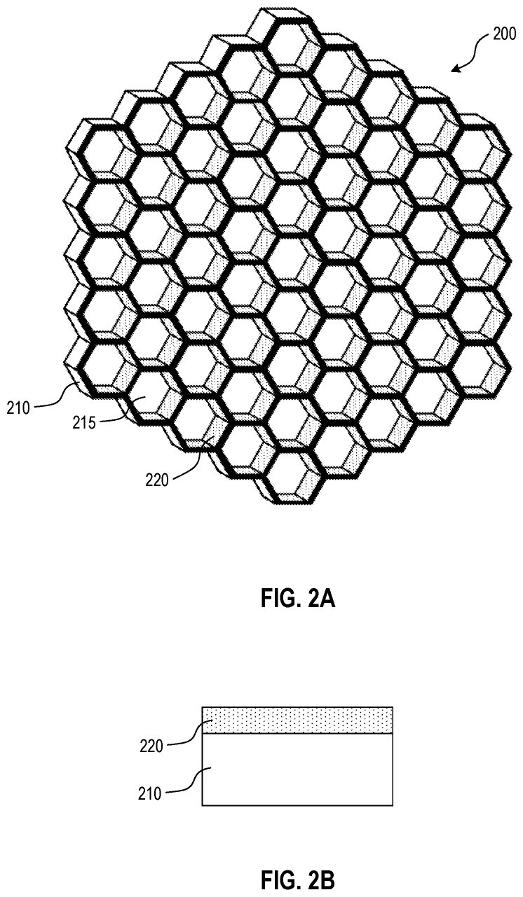

FIGS. 2A and 2B depict a cross-sections of a catalyst-adsorbent filter 200 formed in accordance with an embodiment of the disclosure. The catalyst-adsorbent filter 200 includes a substrate 210, which is illustrated as being in a form of a honeycomb filter with air passageways 215 formed therethrough. It is to be understood that the honeycomb filter is merely illustrative, and that other filter shapes may be used. The catalyst-adsorbent filter 200 further includes a catalyst-adsorbent material layer 220 onto interior walls of the substrate 210. In some embodiments, one or more additional catalyst-adsorbent material layers may be included above the catalyst-adsorbent material layer 220. In some embodiments, the catalyst-adsorbent material may be in the form of a layer stack, with at least one layer comprising an adsorbent material and at least one layer comprising a catalytic layer. For example, a first layer above the substrate 210 may be an adsorbent layer, and a second layer above the first layer may be a catalyst layer.

In certain embodiments, the filter body may be in the form of an open-pored foam, a honeycomb, or a nonwoven filter body. In certain embodiments, a material of the filter body may be ceramic (e.g., porous ceramic), metallic, polymeric foam, plastic, paper, fibrous (e.g., polymeric fiber), or combinations thereof. For example, in certain embodiments, the filter body may be formed from polyurethane fibers or a polyurethane foam. In certain embodiments, the filter body may be a metallic monolithic filter body, a ceramic monolithic filter body, a paper filter body, a polymer filter body, or a ceramic fiber monolithic substrate. In certain embodiments, the filter body may be an HVAC duct, an air filter, or a louver surface. In certain embodiments, the filter body may be a portable air filter, or a filter disposed in a vehicle, such as a motor vehicle, railed vehicle, watercraft, aircraft, or space craft.

In certain embodiments, the catalyst-adsorbent material may be formulated as a slurry and washcoated onto the filter body. In certain embodiments, a loading of the catalyst-adsorbent material on the filter body may range from about 0.5 Win′ to about 4 Win′ with respect to a volume of the filter body. In certain embodiments, the catalyst-adsorbent material may be coated onto the filter body and may form a single catalyst-adsorbent layer on the solid substrate or a plurality of catalyst-adsorbent layers. If a plurality of catalyst-adsorbent layers is coated on the solid substrate, the layers may vary in their compositions or alternatively all catalyst-adsorbent layers may have the same composition.

In certain embodiments, the catalyst of the catalyst-adsorbent material may comprise one or more of manganese, platinum, palladium, or cerium. In certain embodiments, the catalyst comprises platinum particles having a diameter of at least 2 nanometers (e.g., 2 to 5 nanometers or 2 to 10 nanometers). In certain embodiments, the catalyst comprises platinum-modified alumina. In some embodiments, the catalyst comprises platinum wherein a majority of the platinum is in the Pt⁰ oxidation state. It is understood by those skilled in the art that the Pt⁰ oxidation state can be achieved by several exemplary methods including, but not limited to: addition of a reductant to the formulation, such that it will act to reduce the platinum during calcination; calcination in a controlled environment, such as in the presence of nitrogen or hydrogen; selection of platinum precursor materials prone to the Pt⁰ state; or calcination at elevated temperatures that favor release of the bound oxygen from the platinum. In certain embodiments, the catalyst comprises potassium-modified manganese oxide. In certain embodiments, the catalyst of the catalyst-adsorbent material may comprise a catalytic metal oxide. The catalytic metal oxide may include one or more of manganese oxide, cobalt oxide, molybdenum oxide, chromium oxide, copper oxide, or cerium oxide. In certain embodiments, the metal oxide may be a rare earth metal oxide.

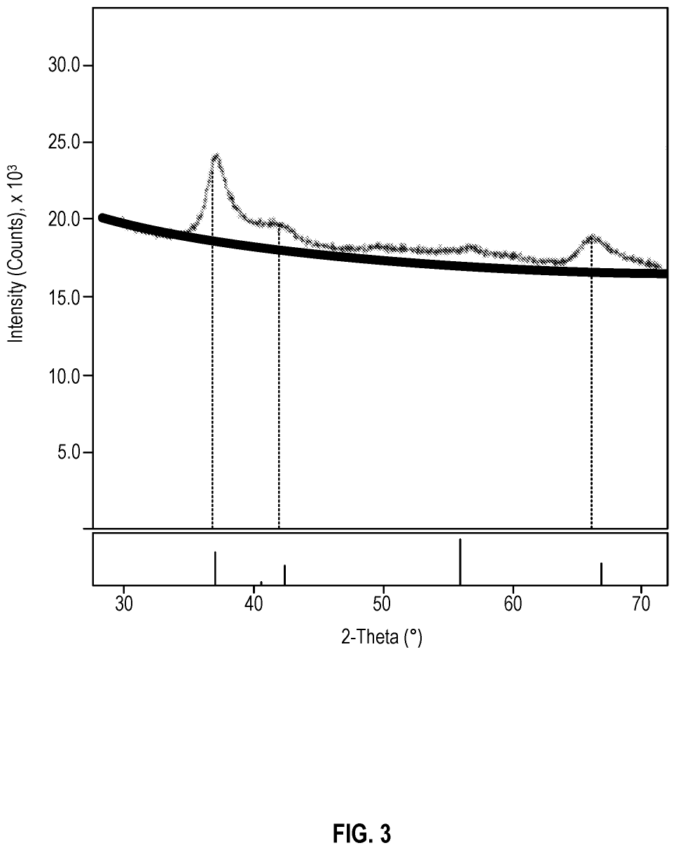

In certain embodiments, the catalytic metal oxide is manganese oxide. In certain embodiments, the manganese oxide is amorphous or at least partially amorphous. In certain embodiments, the manganese oxide is semi-crystalline. In certain embodiments, the manganese oxide may comprise cryptomelane, birnessite, vernadite, manganese oxide polymorph I (having an x-ray diffraction (XRD) spectrum shown in FIG. 3), poorly crystalline cryptomelane, amorphous manganese oxide, polymorphs thereof, amorphous manganese oxide, or mixtures thereof. When manganese oxide polymorph I is present, in some embodiments, the manganese oxide may exhibit an XRD pattern in the range of 20-80 for ° 2θ having at least the following ° 2θ peaks and intensities: 100% for ° 2θ from 36-38; >2θ% for ° 2θ from 41-43; <50% for ° 2θ from 56-58; and >20% for ° 2θ from 65-67, where the percentage corresponds to relative intensity as compared with the primary peak at ° 2θ from 36-38.

In certain embodiments, the catalyst material is present from about 10 wt. % to about 90 wt. %, from about 20 wt. % to about 90 wt. %, from about 30 wt. % to about 90 wt. %, from about 30 wt. % to about 80 wt. %, from about 40 wt. % to about 80 wt. %, or from about 40 wt. % to about 70 wt. % based on a total weight of the catalyst-adsorbent material.

In certain embodiments, the adsorbent of the catalyst-adsorbent material comprises an adsorbent selected from alumina, manganese oxide, silica gel, activated carbon, faujasite, chabazite, clinoptilolite, mordenite, silicalite, zeolite X, zeolite Y, ultrastable zeolite Y, ZSM zeolite (e.g., ZSM-5, ZSM-11), offretite, beta zeolite, metal organic frameworks, metal oxide, polymers, resins, and combinations thereof. In some embodiments, the adsorbent material is a basic metal oxide, such as alkali, alkaline earth, or mixed oxides of various transition metals (e.g., MgAl₂O₄ spinel).

In certain embodiments, the adsorbent may include an adsorbent material may include a primary adsorbent (such as one or more discussed above) on a supporting material, such as carbon, an oxide (e.g., alumina, silica), or zeolite.

In certain embodiments, the adsorbent comprises activated carbon. The activated carbon may be synthetic activated carbon or based on or derived from wood, peat coal, coconut shell, lignite, petroleum pitch, petroleum coke, coal tar pitch, fruit pits, nuts, shells, sawdust, wood flour, synthetic polymer, natural polymer, and combinations thereof.

In certain embodiments, the adsorbent includes a plurality of porous particles in a powder form. In certain embodiments, an average size of the particles/powder ranges from about 1.0 μm to about 100 μm. In certain embodiments, the average size ranges from about 5.0 μm to about 50 μm. In certain embodiments, a BET surface area of the adsorbent is from about 20 m²/g to about 3,000 m²/g, or greater.

In certain embodiments, the BET surface area of the adsorbent is from about 50 m²/g to about 3,000 m²/g. In certain embodiments, the BET surface area of the adsorbent is from about 100 m²/g to about 3,000 m²/g. In certain embodiments, the BET surface area of the adsorbent is from about 250 m²/g to about 3,000 m²/g. In certain embodiments, the BET surface area of the adsorbent is from about 500 m²/g to about 3,000 m²/g. In certain embodiments, the BET surface area of the adsorbent is from about 600 m²/g to about 3,000 m²/g. In certain embodiments, the BET surface area of the adsorbent is from about 700 m²/g to about 3,000 m²/g. In certain embodiments, the BET surface area of the adsorbent is from about 800 m²/g to about 3,000 m²/g. In certain embodiments, the BET surface area of the adsorbent is from about 900 m²/g to about 3,000 m²/g. In certain embodiments, the BET surface area of the adsorbent is from about 1,000 m²/g to about 3,000 m²/g. In certain embodiments, the BET surface area of the adsorbent is from about 1,000 m²/g to about 2,750 m²/g. In certain embodiments, the BET surface area of the adsorbent is from about 1,000 m²/g to about 2,500 m²/g. In certain embodiments, the BET surface area of the adsorbent is from about 1,100 m²/g to about 2,500 m²/g. In certain embodiments, the BET surface area of the adsorbent is from about 1,200 m²/g to about 2,500 m²/g. In certain embodiments, the BET surface area of the adsorbent is from about 1,300 m²/g to about 2,500 m²/g. In certain embodiments, the BET surface area of the adsorbent is from about 1,400 m²/g to about 2,500 m²/g. In certain embodiments, the BET surface area of the adsorbent is from about 1,500 m²/g to about 2,500 m²/g. In certain embodiments, the BET surface area of the adsorbent is from about 1,600 m²/g to about 2,500 m²/g. In certain embodiments, the BET surface area of the adsorbent is from about 1,700 m²/g to about 2,500 m²/g. In certain embodiments, the BET surface area of the adsorbent is from about 1,800 m²/g to about 2,500 m²/g. In certain embodiments, the BET surface area of the adsorbent is from about 1,800 m²/g to about 2,400 m²/g. In certain embodiments, the BET surface area of the adsorbent is from about 1,800 m²/g to about 2,300 m²/g.

In certain embodiments, the adsorbent is activated carbon having a BET surface area from about 1,000 m²/g to about 2,500 m²/g. In certain embodiments, the adsorbent is activated carbon having a BET surface area from about 1,800 m²/g to about 2,300 m²/g.

In order to increase capacity of the porous support utilized in the embodiments of the present disclosure, the adsorbent can be activated. The activation may include subjecting the adsorbent (e.g., particles) to various conditions including, but not limited to, ambient temperature, vacuum, an inert gas flow, or any combination thereof, for a sufficient time to activate the adsorbent. In certain embodiments, the adsorbent may be activated by calcining.

In certain embodiments, a weight-to-weight ratio of the catalyst material to the adsorbent material is from 1:1 to 7:1. In certain embodiments, the weight-to-weight ratio is from 2:1 to 5:1. In certain embodiments, the weight-to-weight ratio may be 1:1, 2:1, 3:1, 4:1, 5:1, 6:1, 7:1, or any combination of subranges defined therebetween. In certain embodiments, the weight-to-weight ratio may be 1:1 to 1:5. In certain embodiments, the weight-to-weight ratio may be 1:1, 1:2, 1:3, 1:4, 1:5, or any combination of subranges defined therebetween.

In certain embodiments, the catalyst-adsorbent material may further comprise a binder. Examples of binders useful in the present embodiments include, but are not limited to, boehmite, alumina, silica, titania, zirconium acetate, ceria, and combinations thereof. Examples of suitable polymeric binders may include but are not limited to: polyethylene, polypropylene, polyolefin copolymers, polyisoprene, polybutadiene, polybutadiene copolymers, chlorinated rubber, nitrile rubber, polychloroprene, ethylene-propylene-diene elastomers, polystyrene, polyacrylate, polymethacrylate, polyacrylonitrile, poly(vinyl esters), poly (vinyl halides), polyamides, cellulosic polymers, polyimides, acrylics, vinyl acrylics, styrene acrylics, polyvinyl alcohols, thermoplastic polyesters, thermosetting polyesters, poly(phenylene oxide), poly(phenylene sulfide), fluorinated polymers such as poly(tetrafluoroethylene), polyvinylidene fluoride, poly(vinlyfluoride) and chloro/fluoro copolymers such as ethylene chlorotrifluoroethylene copolymer, polyamide, phenolic resins, polyurethane, acrylic/styrene acrylic copolymer latex and silicone polymers.

In certain embodiments, the binder, or mixture of binders, is present from about 1 wt. % to about 30 wt. % with respect to a total weight of the catalyst-adsorbent material when dried and deposited onto the filter body. In certain embodiments, the polymeric binder is present from about 10 wt. % to about 30 wt. %, from about 15 wt. % to about 30 wt. %, from about 5 wt. % to about 25 wt. %, from about 5 wt. % to about 20 wt. %, from about 10 wt. % to about 20 wt. %, or from about 15 wt. % to about 20 wt. %.

In certain embodiments, the catalyst-adsorbent material includes a dispersant. The dispersant may include one or more of an anionic surfactant, a cationic surfactant, a zwitterionic surfactant, or a nonionic surfactant. In certain embodiments, the dispersant is a nonionic acrylic copolymer.

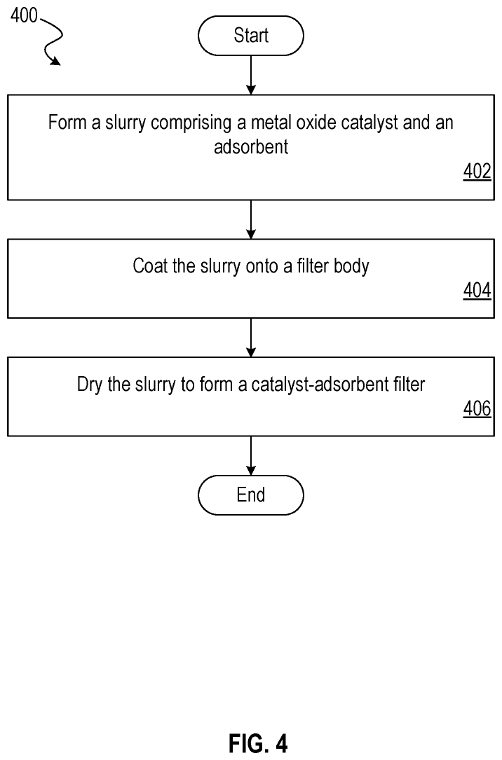

FIG. 4 is a flow diagram illustrating a method 400 of forming a catalyst-adsorbent material in accordance with an embodiment of the disclosure. The method 400 begins at block 402, where a slurry is formed. The slurry comprises a metal oxide catalyst and an adsorbent, which may be formed by dissolving the metal oxide catalyst and adsorbent in an aqueous solution.

In certain embodiments, the slurry further comprises an oxide binder or a polymeric binder, as described above.

In certain embodiments, the slurry further comprises a dispersant. The dispersant may include one or more of an anionic surfactant, a cationic surfactant, a zwitterionic surfactant, or a nonionic surfactant.

In certain embodiments, the slurry further includes an oxidant, which may improve removal efficiency of nitrogen oxides. The oxidant may be selected from nitric acid, hypochlorite, a persulfate, a peroxide, permanganate, or a chlorate.

In certain embodiments, the slurry further includes an alkaline component, such as a hydroxide, ammonia, or a carbonate, which may improve slurry stabilization. In certain embodiments, a pH of the slurry may be adjusted between 2 and 12, or between 4 and 10.

At block 404, the slurry is coated onto a substrate, such as a filter body. The substrate may comprise a material selected from polymeric foam, polymeric fiber, non-woven fabric, a ceramic, or a pulp product (e.g., paper). In certain embodiments, the substrate comprises a polymeric foam comprising polyurethane. In certain embodiments, the substrate is in a form of a honeycomb. In certain embodiments, the substrate is metallic.

At block 406, the slurry is dried to form the catalyst-adsorbent material on the substrate. In certain embodiments, the drying is performed at a temperature from about 80° C. to about 250° C. In certain embodiments, the polymeric binder is present from about 1 wt. % to about 30 wt. % with respect to a total weight of the coating.

It is noted that the blocks of method 400 are not limiting, and that, in certain embodiments, some or all of the blocks of their respective methods may be performed. In certain embodiments, one or more of the blocks may be performed substantially simultaneously. Some blocks may be omitted entirely or repeated.

### ILLUSTRATIVE EXAMPLES

The following examples are set forth to assist in understanding the disclosure and should not, of course, be construed as specifically limiting the embodiments described and claimed herein. Such variations of the embodiments, including the substitution of all equivalents now known or later developed, which would be within the purview of those skilled in the art, and changes in formulation or minor changes in experimental design, are to be considered to fall within the scope of the embodiments incorporated herein.

The following examples were prepared by applying a washcoat of the described composition onto ceramic honeycomb substrate having a cell density of 400 cpsi in the amount of approximately 2 g of catalyst-adsorbent per in³ of substrate volume.

The catalyst-adsorbent coated honeycomb cores having dimensions of about 1 inch diameter by 0.85 inch length were evaluated for adsorption of valeric acid at 120° C. for one hour followed by heating the catalyst to approximately 250° C. During the evaluation the concentration of valeric acid at the inlet of the catalyst-adsorbent was about 8 to 9 ppm with the flow such that a volume hourly space velocity (VHSV) was about 100,000 per hour. The removal efficiency predominantly by adsorption at 120° C. was reported as the amount of valeric acid removal from the gas stream over one hour divided by the total mass flow of valeric acid to the inlet of the catalyst-adsorbent in the same period of time. The catalyst-adsorbent was subsequently heated to about 250° C. and then cooled to establish steady-state for determination of removal efficiency of valeric acid at about 200° C. and 150° C.

### Example 1

The catalyst-adsorbent washcoat of this example had a composition of Pt (2.5%), Pd (7.1%), MnO₂ (4.7%), SiO₂ (3.1%), and Al₂O₃ (80.6%) based on a total weight of the composition. The balance of the washcoat composition was an alumina sol binder material.

A washcoated monolith was prepared by forming an aqueous slurry by combining catalyst-adsorbent powders consisting of Mn/SiO₂/Al₂O₃ support material impregnated with a Pd precursor solution and calcined to 500° C. and an Al₂O₃ support material impregnated with a Pt precursor solution. The slurry was coated on a monolith substrate at a loading of approximately 2.0 g/in³ and calcined to 500° C.

This example was shown to have an average valeric acid removal efficiency of 73.1% after 1 hour at 120° C. The steady-state valeric acid removal efficiency at 150° C. was 52.6% and 90.4% at 200° C.

### Example 2

The catalyst-adsorbent washcoat of this example had a composition of Pt (1.5%), Pd (4.3%), MnO₂ (42.8%), SiO₂ (1.9%), and Al₂O₃ (48.4%). The balance of the washcoat composition was an alumina sol binder material.

A washcoated monolith was prepared by first, forming an aqueous slurry by combining catalyst-adsorbent powders consisting of Mn/SiO₂/Al₂O₃ support material impregnated with a Pd precursor solution and an Al₂O₃ support material impregnated with a Pt precursor solution each having been calcined to 500° C. Next, manganese oxide powder was added to this slurry such that 40% of the total solids was the additional manganese oxide powder. The final slurry was coated on a monolith substrate at a loading of approximately 2.0 g/in³ and calcined to 300° C.

This example was shown to have an average valeric acid removal efficiency of 80.3% after 1 hour at 120° C. The steady-state valeric acid removal efficiency at 150° C. was 66.5% and 91.8% at 200° C.

### Example 3

The catalyst-adsorbent washcoat of this example had a composition of Pt (1.9%), and MnO₂ (93.2%). The balance of the washcoat composition was binder material.

A washcoated monolith was prepared by forming a slurry by impregnating a manganese oxide powder with a Pt precursor solution and combining with an alumina sol binder and water. The slurry was coated on a monolith substrate at a loading of approximately 2.0 g/in³ and calcined to 300° C.

This example was shown to have an average valeric acid removal efficiency of 81.3% after 1 hour at 120° C. The steady-state valeric acid removal efficiency at 150° C. was 75.6% and 93.2% at 200° C.

### Example 4

The catalyst-adsorbent washcoat of this example had a composition of K (5%), and MnO₂ (90.3%). The balance of the washcoat composition was binder material.

A washcoated monolith was prepared by forming a slurry by impregnating a manganese oxide powder with a KOH and calcining to 300° C. and combining with a silica sol binder and water. The slurry was coated on a monolith substrate at a loading of approximately 2.0 g/in³ and calcined to 300° C.

This example was shown to have an average valeric acid removal efficiency of 76.4% after 1 hour at 120° C. The steady-state valeric acid removal efficiency at 150° C. was 79.7% and 91.6% at 200° C.

### Example 5

The catalyst-adsorbent washcoat of this example had a composition of Pt (1.5%), MnO₂ (74.6%), and beta-zeolite (20%). The balance of the washcoat composition was binder material.

A washcoated monolith was prepared by forming a slurry by impregnating a manganese oxide powder with a Pt precursor solution and combining with an alumina sol binder and a beta-zeolite powder at an amount of 20% of the total solids. The slurry was coated on a monolith substrate at a loading of approximately 2.0 g/in³ and calcined to 300° C.

This example was shown to have an average valeric acid removal efficiency of 69.0% after 1 hour at 120° C. The steady-state valeric acid removal efficiency at 150° C. was 59.6% and 92.3% at 200° C.

### Example 6

The catalyst-adsorbent washcoat of this example had a composition of Pt (1.0%), Al₂O₃ (47%), K (2.4%), and MnO₂ (44.7%). The balance of the washcoat composition was an alumina sol binder material.

A washcoated monolith was prepared by forming an aqueous slurry by combining catalyst-adsorbent powders consisting of an Al₂O₃ support material impregnated with a Pt precursor solution having been calcined to 500° C. and manganese oxide impregnated with KOH calcined to 300° C. The K modified manganese oxide powder was added to this slurry such that 40% of the total solids was the K/MnO₂ powder. The final slurry was coated on a monolith substrate at a loading of approximately 2.0 g/in³ and calcined to 300° C.

This example was shown to have an average valeric acid removal efficiency of 72.0% after 1 hour at 120° C. The steady-state valeric acid removal efficiency at 150° C. was 65.2% and 91.2% at 200° C.

### Example 7

A washcoated monolith was prepared by first, forming an aqueous slurry by combining catalyst-adsorbent powders of Mn/SiO₂/Al₂O₃ support material impregnated with a Pd precursor solution and an Al₂O₃ support material impregnated with a Pt precursor solution each having been calcined to 500° C. Next, manganese oxide powder was added to this slurry such that 20% of the total solids of this slurry was the additional manganese oxide powder. Finally, zeolite powder was added to the previously prepared slurry in an amount equal to 20% solids of the final slurry solids. This final slurry was coated on a monolith substrate at a loading of approximately 2.5 g/in³ and calcined to 300° C.

This example was shown to have an average valeric acid removal efficiency of 83.8% after 1 hour at 120° C. The steady-state valeric acid removal efficiency at 150° C. was 70.6% and 91.5% at 200° C.

In the foregoing description, numerous specific details are set forth, such as specific materials, dimensions, processes parameters, etc., to provide a thorough understanding of the embodiments of the present disclosure. The particular features, structures, materials, or characteristics may be combined in any suitable manner in one or more embodiments. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the use of the terms “a,” “an,” “the,” and similar referents in the context of describing the materials and methods discussed herein (especially in the context of the following claims) are to be construed to cover both the singular and the plural, unless otherwise indicated herein or clearly contradicted by context.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Reference throughout this specification to “one embodiment,” “certain embodiments,” “one or more embodiments,” “an embodiment,” or “some embodiments” means that a particular feature, structure, material, or characteristic described in connection with the embodiment is included in at least one embodiment of the present disclosure. Thus, the appearances of the phrases such as “in one or more embodiments,” “in certain embodiments,” “in one embodiment,” or “in an embodiment” in various places throughout this specification are not necessarily referring to the same embodiment of the present disclosure. Furthermore, the particular features, structures, materials, or characteristics may be combined in any suitable manner in one or more embodiments.

It is to be understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled. The use of any and all examples, or exemplary language (e.g., “such as”) provided herein, is intended merely to better illuminate the materials and methods and does not pose a limitation on the scope unless otherwise claimed. No language in the specification should be construed as indicating any non-claimed element as essential to the practice of the disclosed materials and methods.

Although the embodiments disclosed herein have been described with reference to particular embodiments it is to be understood that these embodiments are merely illustrative of the principles and applications of the present disclosure. It will be apparent to those skilled in the art that various modifications and variations can be made to the method and apparatus of the present disclosure without departing from the spirit and scope of the disclosure. Thus, it is intended that the present disclosure include modifications and variations that are within the scope of the appended claims and their equivalents, and the above-described embodiments are presented for purposes of illustration and not of limitation.

1. A system for removing pollutants from an air flow, the system comprising:
a substrate; and
a catalyst-adsorbent material disposed on the substrate, the catalyst-adsorbent material comprising an adsorbent material and a catalyst material, wherein the catalyst-adsorbent material is adapted to adsorb pollutants at a first temperature of 20-150° C. and catalyze adsorbed pollutants at a second temperature of 120-300° C.

2. The system of claim 1, wherein the adsorbent material comprises one or more of silica gel, alumina, activated carbon, faujasite, chabazite, clinoptilolite, mordenite, silicalite, zeolite X, zeolite Y, ultrastable zeolite Y, ZSM zeolite, offretite, beta zeolite, metal organic frameworks, metal oxide, polymers, or resins.

3. The system of claim 1, wherein the adsorbent material comprises one or more of a basic metal oxide or an alkali-modified or alkaline earth-modified metal oxide.

4. The system of claim 1, wherein the adsorbent material comprises one or more of a potassium-modified manganese oxide or a sodium-exchanged zeolite.

5. The system of claim 1, wherein the catalyst material comprises one or more of manganese, platinum, palladium, or cerium.

6. The system of claim 1, wherein the catalyst-adsorbent material comprises platinum particles having a diameter of 2 nanometers to 5 nanometers and manganese oxide.

7. The system of claim 1, wherein the catalyst-adsorbent material comprises platinum particles having a diameter of 2 nanometers to 5 nanometers, manganese, and cerium.

8. The system of claim 1, wherein the catalyst-adsorbent material comprises platinum-modified alumina and potassium-modified manganese oxide.

9. The system of claim 1, wherein the catalyst-adsorbent material comprises platinum-modified alumina, potassium-modified manganese oxide, and zeolite.

10. The system of claim 1, wherein the pollutants comprise one or more volatile organic compounds.

11. The system of claim 10, wherein the one or more volatile organic compounds comprise one or more of pentanoic acid, acetaldehyde, toluene, turbine oil compounds, polyol esters, tri-cresyl phosphate, phosphate esters, hydraulic fluid compounds, jet fuel compounds, dodecane, propionic acid, or carboxylic acids.

12. The system of claim 1, wherein the pollutants comprise one or more of SO₂, NH₃, NO₂, NO, or formaldehyde.

13. The system of claim 1, wherein the catalyst-adsorbent material comprises a washcoat formed on the substrate, the washcoat comprising a physical mixture of the adsorbent material and the catalyst material.

14. The system of claim 13, wherein the washcoat comprises a polymeric binder, and wherein the polymeric binder is selected from a group consisting of: polyethylene, polypropylene, polyolefin copolymer, polyisoprene, polybutadiene, polybutadiene copolymer, chlorinated rubber, nitrile rubber, polychloroprene, ethylene-propylene-diene elastomer, polystyrene, polyacrylate, polymethacrylate, polyacrylonitrile, poly(vinyl ester), poly(vinyl halide), polyamide, cellulosic polymer, polyimide, acrylic polymer, vinyl acrylic polymer, styrene acrylic polymer, polyvinyl alcohol, thermoplastic polyester, thermosetting polyester, poly(phenylene oxide), poly(phenylene sulfide), fluorinated polymer, poly(tetrafluoroethylene) polyvinylidene fluoride, poly(vinylfluoride) chloro/fluoro copolymer, ethylene chlorotrifluoroethylene copolymer, polyamide, phenolic resin, epoxy resin, polyurethane, acrylic/styrene acrylic copolymer, latex, silicone polymer, and combinations thereof.

15. The system of claim 13, wherein the washcoat comprises an inorganic binder.

16. The system of claim 15, wherein the inorganic binder comprises one or more of a silica sol or an alumina sol.

17. A system for removing pollutants from an air flow, the system comprising:
a first catalyst-adsorbent material layer on a first substrate; and
a second catalyst-adsorbent material layer on a second substrate downstream from the first substrate, wherein one or more of the first catalyst-adsorbent material layer or the second catalyst-adsorbent material layer is adapted to adsorb pollutants at a first temperature of 20-150° C. and catalyze adsorbed pollutants at a second temperature of 120-300° C.

18. A system for removing pollutants from an air flow, the system comprising:
a first catalyst-adsorbent material layer to adsorb a pollutant and/or generate an intermediate compound from the pollutant; and
a second catalyst-adsorbent material layer downstream from the first catalyst-adsorbent material layer, wherein the second catalyst-adsorbent material layer is adapted to convert the pollutant after desorption from the first catalyst-adsorbent material layer and/or the intermediate compound.

19. (canceled)

20. (canceled)

21. An aircraft environmental control system for removing pollutants from aircraft cabin air, the aircraft environmental control system comprising the system of claim 1.

22. An aircraft environmental control system comprising a catalytic convertor for removing pollutants from aircraft cabin air, the catalytic convertor comprising the system of claim 1.

23. (canceled)
